(19) United States
(12) Patent Application Publication
(10) Pub. No.: US 2024/0176583 A1
(43) Pub. Date: May 30, 2024

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventor: Takashi KATOH, Kawasaki (JP)

(73) Assignee: Fujitsu Limited, Kawasaki-shi (JP)

(21) Appl. No.: 18/370,436

(22) Filed: Sep. 20, 2023

(30) Foreign Application Priority Data
Nov. 29, 2022 (JP) 2022-189894

(51) Int. Cl. G06F 7/24; G06F 7/78

(52) U.S. Cl. CPC G06F 7/24; G06F 7/78

(57) ABSTRACT

For managing an order of pieces of data, a computer stores, in order, a plurality of pieces of value data that represent a number of digits with which a constant multiple of a number of pieces of data included in a data group are representable; stores flag defining an upper-lower relationship between first and second ranges in each of which at least the number of pieces of data is representable; each time designation of first value data to be moved to a head in the order is accepted, sets a value that belongs to an upper range among the first and the second ranges to the first value data such that the first value data is before other pieces of value data in the order; and when the lower range no longer includes any pieces of value data, updates the flag such that the upper-lower relationship is switched.

### CROSS-REFERENCE TO RELATED APPLICATION

This application is based upon and claims the benefit of priority of the prior Japanese Patent Application No. 2022-189894, filed on Nov. 29, 2022, the entire contents of which are incorporated herein by reference.

### FIELD

The embodiment discussed herein is related to a computer-readable recording medium storing an information processing program, an information processing method, and an information processing apparatus.

### BACKGROUND

In related art, it is desired to manage an order relationship between pieces of data included in a plurality of pieces of data. For example, it is desired to enable the order relationship between the pieces of data included in the plurality of pieces of data to be changed or enable the order relationship between the pieces of data included in the plurality of pieces of data to be referred to. For example, it is conceivable that a counter value is prepared, and each time any piece of data included in the plurality of pieces of data is updated, the counter value is given to the any piece of data and is counted up, so that the order relationship between the pieces of data included in the plurality of pieces of data related to the update is managed.

As related art, for example, there is a technique for rewriting count data of a counter for the number of rotations of a drive shaft that drives a control-target object to a value obtained by subtracting, from this count data, a counted number at one round or a plurality of rounds of a predetermined point of the control-target object.

Japanese Laid-open Patent Publication No. 4-215011 is disclosed as related art.

### SUMMARY

According to an aspect of the embodiments, a computer-readable recording medium storing an information processing program for causing a computer to execute a process including: storing, in order, a plurality of pieces of value data that represent values of a number of digits with which a constant multiple of a number of pieces of data included in a data group are representable and that are associated with respective different pieces of data included in the data group; storing flag information that defines an upper-lower relationship between a first range and a second range among a plurality of ranges which are set for the values of the number of digits and in each of which at least the number of pieces of data is representable; setting, with reference to the flag information, a value that belongs to a lower range among the first range and the second range to each piece of value data of the plurality of pieces of value data; each time designation of first value data to be moved to a head in the order among the plurality of pieces of value data is accepted, setting, with reference to the flag information, a value that belongs to an upper range among the first range and the second range to the first value data such that the first value data is before other pieces of value data in the order; and in response to a piece of value data to which a value that belongs to the lower range has been set no longer existing among the plurality of pieces of value data, updating the flag information such that the upper-lower relationship between the first range and the second range is switched.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system;

FIG. 3 is a block diagram illustrating an example of a hardware configuration of an information processing apparatus;

FIG. 4 is a block diagram illustrating an example of a functional configuration of the information processing apparatus;

FIG. 5 is an explanatory diagram illustrating an example of storing array information;

FIG. 6 is an explanatory diagram illustrating an example of relationships between flag information and various ranges;

FIG. 7 is an explanatory diagram (part 1) illustrating an example of managing an order of elements of an array;

FIG. 8 is an explanatory diagram (part 2) illustrating an example of managing the order of the elements of the array;

FIG. 9 is an explanatory diagram (part 3) illustrating an example of managing the order of the elements of the array;

FIG. 10 is an explanatory diagram (part 4) illustrating an example of managing the order of the elements of the array;

FIG. 11 is an explanatory diagram (part 5) illustrating an example of managing the order of the elements of the array;

FIG. 12 is an explanatory diagram (part 6) illustrating an example of managing the order of the elements of the array;

FIG. 13 is an explanatory diagram (part 7) illustrating an example of managing the order of the elements of the array;

FIG. 14 is an explanatory diagram (part 8) illustrating an example of managing the order of the elements of the array;

FIG. 15 is an explanatory diagram illustrating a specific example of managing files;

FIG. 16 is an explanatory diagram illustrating an example of an effect produced by the information processing apparatus;

FIG. 17 is a flowchart illustrating an example of a procedure of initialization processing;

FIG. 18 is a flowchart illustrating an example of a procedure of mode change processing;

FIG. 19 is a flowchart illustrating an example of a procedure of averaging movement processing;

FIG. 20 is a flowchart illustrating an example of a procedure of head movement processing;

FIG. 21 is a flowchart illustrating an example of a procedure of tail movement processing; and

FIG. 22 is a flowchart illustrating an example of a procedure of comparison processing.

### DESCRIPTION OF EMBODIMENTS

In the related art, management of an order relationship between pieces of data is difficult in some cases. For example, when the number of digits of the counted-up counter value exceeds an upper limit number of digits assumed in advance, the order relationship between the pieces of data may no longer be appropriately managed in some cases.

In one aspect, an object of the present disclosure is to make it easier to manage an order relationship between pieces of data.

Hereinafter, an embodiment of an information processing program, an information processing method, and an information processing apparatus according to the present disclosure will be described in detail with reference to the drawings.

### Example of Information Processing Method According to Embodiment

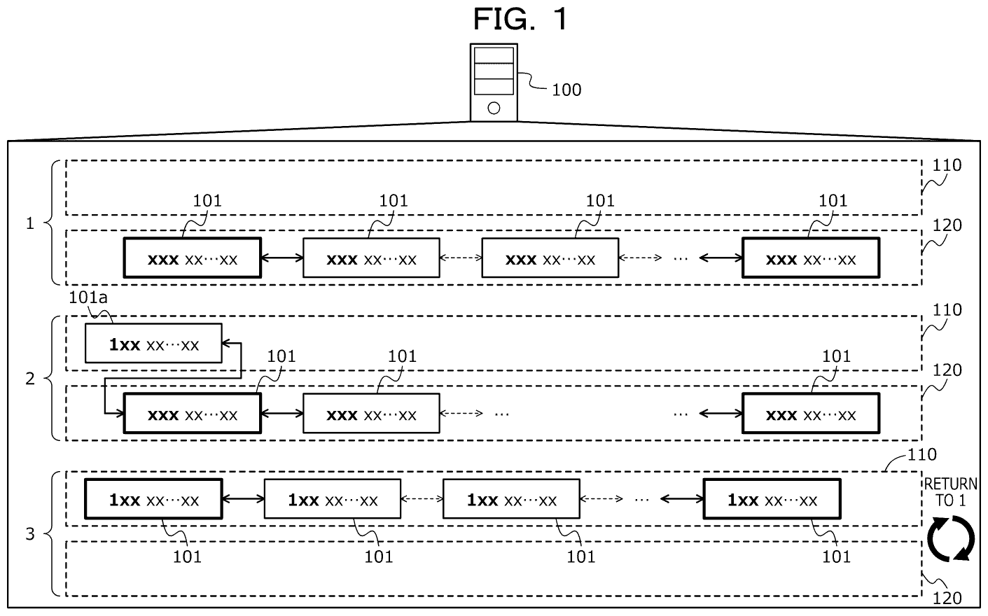

FIG. 1 is an explanatory diagram illustrating an example of an information processing method according to an embodiment. An information processing apparatus 100 is a computer for managing an order relationship between pieces of data included in a plurality of pieces of data. For example, the information processing apparatus 100 is a server, a personal computer (PC), or the like.

It is desired to manage an order relationship between pieces of data included in a plurality of pieces of data in some cases. For example, it is desired to enable the order relationship between the pieces of data included in the plurality of pieces of data to be changed. For example, it is desired to enable “movement processing” to be performed in which an order of any piece of data included in the plurality of pieces of data is changed to the first in the order or the last in the order.

For example, it is desired to enable the order relationship between the pieces of data included in the plurality of pieces of data to be referred to. For example, it is desired to enable “comparison processing” to be performed in which the orders of respective pieces of data that are two different pieces of data included in the plurality of pieces of data are compared with each other and it is determined whether the order of one of the two pieces of data is an order before the order of the other piece of data.

From the viewpoint of making use of the plurality of pieces of data, it is desired to achieve reductions in a processing load and a processing time for managing the order relationship between the pieces of data included in the plurality of pieces of data. For example, it is conceivable that the plurality of pieces of data are pieces of data used for real-time transactions, online games, automatic driving, security measures, or the like.

However, in the related art, management of the order relationship between the pieces of data included in the plurality of pieces of data is difficult in some cases. This may lead to increases in the processing load and the processing time for managing the order relationship between the pieces of data included in the plurality of pieces of data.

For example, a first method is conceivable in which an order relationship between pieces of data included in a plurality of pieces of data is managed by setting each piece of data of the plurality of pieces of data as a component of an array. For example, an index of a component in which each piece of data is set is used as a value indicating an order of this piece of data. For example, the above-described “comparison processing” is performed by determining that the order of first data is an order before the order of second data if an index of a component in which the first data is set is smaller than an index of a component in which the second data is set. For example, the above-described “movement processing” is performed by setting each piece of data of the plurality of pieces of data as a component of the array again when the order of any piece of data included in the plurality of pieces of data is changed to the first in the order or the last in the order.

This first method has an issue in that a processing load and a processing time for the above-described “movement processing” are greater than those of a second method, a third method, and the like described later. For example, since each piece of data of the plurality of pieces of data is set as a component of the array again, the processing load and the processing time for the above-described “movement processing” become a magnitude of O(N). O(·) denotes an order. N denotes the number of pieces of data.

For example, the second method is conceivable in which an order relationship between pieces of data included in a plurality of pieces of data is managed by setting each piece of data of the plurality of pieces of data as a component of a list coupled by pointers. For example, the above-described “comparison processing” is performed by tracing the components of the list sequentially from a head to a tail in accordance with the pointers, and determining whether a component in which one piece of data of two different pieces of data is set exists before a component in which the other piece of data is set. For example, the above-described “movement processing” is performed by changing a coupling relationship between components of the list indicated by the pointers and moving the component in which any piece of data of the plurality of pieces of data is set to the head or the tail of the list.

This second method has an issue in that a processing load and a processing time for the above-described “comparison processing” are greater than those of the first method described above and the third method and the like described later. For example, since the components of the list are sequentially traced from the head to the tail in accordance with the pointers, the processing load and the processing time for the above-described “comparison processing” become a magnitude of O(N). O(·) denotes an order. N denotes the number of pieces of data.

For example, the third method is conceivable in which an order relationship between pieces of data included in a plurality of pieces of data is managed by setting each piece of data of the plurality of pieces of data as a node of a tree structure.

This third method has an issue in that a processing load and a processing time for the above-described “comparison processing” are greater than those of the first method and the like described above. For example, the processing load and the processing time for the above-described “comparison processing” become a magnitude of O(log N). O(·) denotes an order. N denotes the number of pieces of data.

The third method also has an issue in that a processing load and a processing time for the above-described “movement processing” are greater than those of the second method or the like described above. For example, the processing load and the processing time for the above-described “movement processing” become a magnitude of O(log N). O(·) denotes an order. N denotes the number of pieces of data.

Thus, it is difficult to efficiently reduce both the processing load and the processing time for the above-described “comparison processing” and the processing load and the processing time for the above-described “movement processing”, and it is difficult to manage an order relationship between pieces of data included in a plurality of pieces of data.

In contrast, a fourth method is conceivable in which, for example, a counter value is prepared and an order relationship between pieces of data included in a plurality of pieces of data is managed by using the counter value. For example, the above-described “movement processing” is performed by, each time the order of any piece of data included in the plurality of data is changed to the first in the order, giving the prepared counter value to the any piece of data and counting up the counter value. For example, the above-described “comparison processing” is performed by comparing the counter values given to the respective pieces of data. The use of a timestamp instead of the counter value is also conceivable.

The fourth method has an issue in that, when the number of digits of the counted up counter value exceeds an upper limit number of digits assumed in advance, the order relationship between the pieces of data may no longer be appropriately managed. For example, as a result of comparing the counter values given to respective pieces of data that are the two pieces of data, it may be erroneously determined whether or not the order of one piece of data of the two pieces of data is an order before the order of the other piece of data.

For these reasons, it is desired to appropriately manage the order relationship between the pieces of data while efficiently reducing both of the processing load and the processing time for the above-described “comparison processing” and the processing load and the processing time for the above-described “movement processing”.

Accordingly, in the present embodiment, an information processing method that may make it easier to manage an order relationship between pieces data will be described.

In FIG. 1, the information processing apparatus 100 stores a data group. The information processing apparatus 100 stores, in order, a plurality of pieces of value data 101 associated with respective different pieces of data included in the data group. For example, the pieces of value data 101 represent values of a predetermined number of digits. For example, the predetermined number of digits is a number of digits with which as many values as a constant multiple of the number of pieces of data included in the data group are representable.

For example, the information processing apparatus 100 stores, in order, the plurality of pieces of value data 101 that represent values of the number of digits (log N+x) and that are associated with respective different pieces of data included in the data group. N is the number of pieces of data included in the data group. For example, x is equal to 2. The values of the predetermined number of digits are, for example, values from “000 . . . 0” to “111 . . . 1”. For the values of the predetermined number of digits, a plurality of ranges are set in each of which at least the number of pieces of data is representable. For example, for the values of the predetermined number of digits, a range from “000 . . . 0” to “011 . . . 1” and a range from “100 . . . 0” to “111 . . . 1” are set.

The information processing apparatus 100 stores flag information that defines an upper-lower relationship (a before-after relationship in order) between a first range 110 and a second range 120 among the plurality of ranges set for the values of the predetermined number of digits. The first range 110 is, for example, a range from “000 . . . 0” to “011 . . . 1”. The second range 120 is, for example, a range from “100 . . . 0” to “111 . . . 1”. For example, it is assumed that the first range 110 is upper than the second range 120 in an initial state. The first range 110 being upper than the second range 120 means that the values included in the first range 110 are before the values included in the second range 120 in the order relationship between pieces of data.

For example, when the value of the flag information is 0, the flag information indicates that the first range 110 is upper than the second range 120. For example, when the value of the flag information is 1, the flag information indicates that the second range 120 is upper than the first range 110. For example, in the initial state, the information processing apparatus 100 stores the flag information of O which indicates that the first range 110 is upper than the second range 120.

(1-1) As shown in 1 of FIG. 1, the information processing apparatus 100 identifies a lower range among the first range 110 and the second range 120 with reference to the flag information. For example, since the flag information is 0, the information processing apparatus 100 identifies the second range 120 as the lower range among the first range 110 and the second range 120.

The information processing apparatus 100 sets a value that belongs to the identified lower range to each piece of value data 101 of the plurality of pieces of value data 101. For example, the information processing apparatus 100 sets a value that belongs to the second range 120 identified as the lower range to each piece of value data 101 of the plurality of pieces of value data 101. For example, the information processing apparatus 100 sets the same value that belongs to the second range 120 identified as the lower range to each piece value data 101 of the plurality of pieces of value data 101.

(1-2) As shown in 2 of FIG. 1, the information processing apparatus 100 accepts designation of first value data 101 to be moved to a head in order among the plurality of pieces of value data 101. For example, based on an input operation of a user, the information processing apparatus 100 accepts designation of the first value data 101 to be moved to the head in the order. For example, in the example illustrated in FIG. 1, the information processing apparatus 100 accepts designation of first value data 101a to be moved to the head in the order.

Each time the information processing apparatus 100 accepts designation of the first value data 101, the information processing apparatus 100 identifies an upper range among the first range 110 and the second range 120 with reference to the flag information. For example, in the example illustrated in FIG. 1, since the flag information is 0, the information processing apparatus 100 identifies the first range 110 as the upper range among the first range 110 and the second range 120.

Each time the information processing apparatus 100 accepts designation of the first value data 101, the information processing apparatus 100 sets a value that belongs to the identified upper range to the designated first value data 101 such that the designated first value data 101 is before the other pieces of value data 101 in the order. For example, the information processing apparatus 100 sets a value smaller than any value already set to the other pieces of value data 101 among values that belong to the identified upper range, to the designated first value data 101. For example, in the example illustrated in FIG. 1, the information processing apparatus 100 sets a value “1xx . . . xx” that belongs to the first range 110 identified as the upper range, to the designated first value data 101a.

Accordingly, if the values that belong to the upper range are already set to the two or more pieces of value data 101, the information processing apparatus 100 may compare the values already set to the respective pieces of value data 101 that are the two or more pieces of value data 101 among the values that belong to the upper range. Based on a result of the comparison, the information processing apparatus 100 may determine an order relationship between the respective pieces of value data 101 that are the two or more pieces of value data 101. The information processing apparatus 100 may determine that the piece of value data 101 to which a value that belongs to the upper range is already set is before in the order the value data 101 to which a value that belongs to the lower range is already set.

(1-3) As shown in 3 of FIG. 1, when the value data 101 to which a value that belongs to the lower range has been set no longer exists among the plurality of pieces of value data 101, the information processing apparatus 100 updates the flag information such that the upper-lower relationship between the first range 110 and the second range 120 is switched. For example, in the example illustrated in FIG. 1, when the value data 101 to which a value that belongs to the second range 120 identified as the lower range has been set no longer exists, the information processing apparatus 100 updates the flag information to 1.

Accordingly, the information processing apparatus 100 may return a state to a state in which the values that belong to the lower range have been set to the plurality of pieces of value data 101 again. As in (1-2), the information processing apparatus 100 may set a value that belongs to the upper range to the value data 101 to which a value that belongs to the lower range is already set. Thus, the information processing apparatus 100 may suppress exhaustion of values to be set to the pieces of value data 101, and may appropriately manage the order relationship between two or more pieces of data that are included in the data group and are associated with respective different pieces of value data 101.

By simply comparing the values set to the respective pieces of value data 101, the information processing apparatus 100 may determine the order relationship between the two or more pieces of data that are included in the data group and are associated with the respective different pieces of value data 101. Thus, the information processing apparatus 100 may achieve reductions in the processing load and the processing time for determining the order relationship between the two or more pieces of data that are included in the data group and are associated with the respective different pieces of value data 101. For example, the information processing apparatus 100 may suppress the processing load and the processing time for determining the order relationship between the two or more pieces of data that are included in the data group and are associated with the respective different pieces of value data 101 to O(1).

By setting a value that belongs to the upper range to the designated first value data 101, the information processing apparatus 100 may change the order of the data associated with the designated first value data 101 in the data group to the first in the order. Thus, the information processing apparatus 100 may achieve reductions in the processing load and the processing time for changing the order of the data associated with the designated first value data 101 in the data group to the first in the order. For example, the information processing apparatus 100 may suppress the processing load and the processing time for changing the order of data associated with the designated first value data 101 in the data group to the first in the order to O(1).

The case has been described where the information processing apparatus 100 is capable of setting a value that belongs to the upper range to the designated first value data 101 such that the designated first value data 101 is before the other pieces of value data 101 in the order. However, the configuration is not limited to this. For example, there may be a case where the information processing apparatus 100 is capable of setting a value that belongs to the lower range to designated second value data 101 such that the designated second value data 101 is after the other pieces of value data 101 in the order.

For example, there may be a case where the information processing apparatus 100 is capable of setting a value that belongs to the upper range to the designated first value data 101 and setting a value that belongs to the lower range to the designated second value data 101. In this case, it is conceivable that four ranges different from one another are set for the values of the predetermined number of digits.

The case has been described where the information processing apparatus 100 operates alone. However, the configuration is not limited to this. For example, there may be a case where the information processing apparatus 100 operates in cooperation with other computers. For example, there may be a case where the information processing apparatus 100 accepts designation of the first value data 101 to be moved to the head in the order by receiving the designation from another computer. For example, there may be a case where the information processing apparatus 100 does not store the plurality of pieces of value data 101 and controls another computer that stores the plurality of pieces of value data 101.

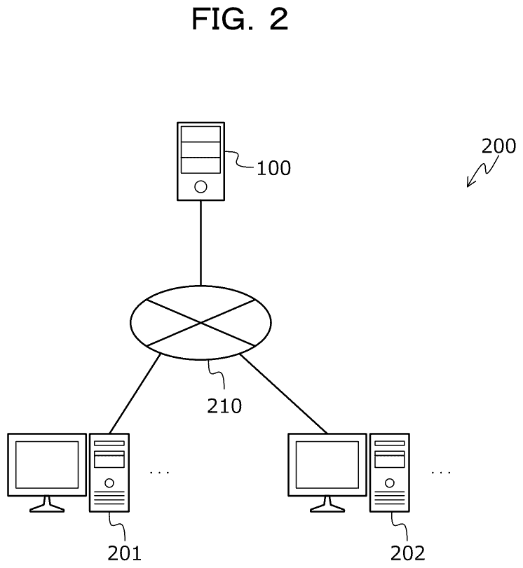

For example, there may be a case where a plurality of computers operate in cooperation with each other to implement the functions of the information processing apparatus 100. For example, there may be a case where the functions of the information processing apparatus 100 are implemented in the cloud. For example, an example of the case where the information processing apparatus 100 does not operate alone but cooperates with other computers will be described later by using FIG. 2.

### Example of Information Processing System 200

An example of an information processing system 200 to which the information processing apparatus 100 illustrated in FIG. 1 is applied will be described next by using FIG. 2.

FIG. 2 is an explanatory diagram illustrating an example of the information processing system 200. In FIG. 2, the information processing system 200 includes the information processing apparatus 100, at least one information accumulation apparatus 201, and at least one client apparatus 202.

In the information processing system 200, the information processing apparatus 100 and the client apparatus 202 are coupled to each other via a wired or wireless network 210. For example, the network 210 is a local area network (LAN), a wide area network (WAN), the Internet, or the like.

For example, the information accumulation apparatus 201 is a computer that stores a data group. For example, the information accumulation apparatus 201 stores, in order, a plurality of pieces of value data that are associated with respective different pieces of data included in the data group. For example, the information accumulation apparatus 201 stores, in order, a plurality of pieces of value data that represent values of a number of digits “log N+3” and that are associated with respective different pieces of data included in the data group. N is the number of pieces of data included in the data group.

For example, the information processing apparatus 100 stores flag information that defines an upper-lower relationship between at least any two ranges among a plurality of ranges set for the values of the predetermined number of digits. For example, the information accumulation apparatus 201 stores flag information that defines an upper-lower relationship between a first range and a second range and an upper-lower relationship between a third range and a fourth range among the plurality of ranges set for the values of the predetermined number of digits. For example, the third range and the fourth range are lower than the first range and the second range. For example, when the value of the flag information is 0, the flag information indicates that the first range is upper than the second range and the third range is upper than the fourth range. For example, when the value of the flag information is 1, the flag information indicates that the second range is upper than the first range and the fourth range is upper than the third range.

For example, the information accumulation apparatus 201 updates data included in the data group in accordance with control of the information processing apparatus 100. For example, the information accumulation apparatus 201 updates all or any of the plurality of pieces of value data in accordance with control of the information processing apparatus 100. For example, the information accumulation apparatus 201 updates the flag information in accordance with control of the information processing apparatus 100. For example, the information accumulation apparatus 201 is a server, a PC, a storage device, or the like.

The information processing apparatus 100 is a computer that controls the information accumulation apparatus 201. For example, the information processing apparatus 100 controls the information accumulation apparatus 201 such that a value that belongs to a lower range among the first range and the second range is set to each piece of value data of the plurality of pieces of value data. For example, the information processing apparatus 100 controls the information accumulation apparatus 201 such that the same value that belongs to the lower range among the first range and the second range is set to each piece of value data of the plurality of pieces of value data. Accordingly, the information processing apparatus 100 may initialize the plurality of pieces of value data.

The information processing apparatus 100 accepts designation of first value data to be moved to a head in the order among the plurality of pieces of value data. For example, the information processing apparatus 100 accepts designation of the first value data to be moved to the head in the order by receiving, from the client apparatus 202, a notification including the designation of the first value data to be moved to the head in the order. For example, the notification may include designation of any data of the data group, and thus indirectly designate the first value data associated with the designated data.

Each time the information processing apparatus 100 accepts designation of the first value data, the information processing apparatus 100 controls the information accumulation apparatus 201 to set, with reference to the flag information, a value that belongs to an upper range among the first range and the second range to the designated first value data. For example, the information processing apparatus 100 controls the information accumulation apparatus 201 to set a value that belongs to the upper range among the first range and the second range to the designated first value data such that the designated first value data is an order before the other pieces of value data. Accordingly, the information processing apparatus 100 may set the order of the designated first value data to be before the order of the other pieces of value data in the order, and may appropriately manage the order of data associated with the designated first value data in the data group.

The information processing apparatus 100 accepts designation of second value data to be moved to a tail in the order among the plurality of pieces of value data. For example, the information processing apparatus 100 accepts designation of the second value data to be moved to the tail in the order by receiving, from the client apparatus 202, a notification including the designation of the second value data to be moved to the tail in the order. For example, the notification may include designation of any data of the data group, and thus indirectly designate the second value data associated with the designated data.

Each time the information processing apparatus 100 accepts designation of the second value data, the information processing apparatus 100 controls the information accumulation apparatus 201 to set, with reference to the flag information, a value that belongs to a lower range among the third range and the fourth range to the designated second value data. For example, the information processing apparatus 100 controls the information accumulation apparatus 201 to set a value that belongs to the lower range among the third range and the fourth range to the designated second value data such that the designated second value data is an order after the other pieces of value data. Accordingly, the information processing apparatus 100 may set the order of the designated second value data to be after the order of the other pieces of value data in the order, and may appropriately manage the order of data associated with the designated second value data in the data group.

The information processing apparatus 100 detects value data to which a value that belongs to the lower range among the first range and the second range has been set no longer existing and value data to which a value that belongs to the upper range among the third range and the fourth range has been set no longer existing among the plurality of pieces of value data. In response to the detection, the information processing apparatus 100 controls the information accumulation apparatus 201 to update the flag information such that the upper-lower relationship between the first range and the second range is switched and the upper-lower relationship between the third range and the fourth range is switched. Accordingly, the information processing apparatus 100 may accept designation of the first value data and designation of the second value data again, and may enable the update of the plurality of pieces of value data. For example, the information processing apparatus 100 is a server, a PC, or the like.

The client apparatus 202 is a computer used by a system user who intends to use data included in the data group. Based on an input operation of the system user, the client apparatus 202 generates a notification including designation of the first value data to be moved to the head in the order among the plurality of pieces of value data, and transmits the notification to the information processing apparatus 100. Based on an input operation of the system user, the client apparatus 202 generates a notification including designation of the second value data to be moved to the tail in the order among the plurality of pieces of value data, and transmits the notification to the information processing apparatus 100. The client apparatus 202 is, for example, a PC, a tablet terminal, a smartphone, or the like.

The case has been described where the information processing apparatus 100 is an apparatus different from the information accumulation apparatus 201. However, the configuration is not limited to this. For example, there may be a case where the information processing apparatus 100 has the functions of the information accumulation apparatus 201 and operates also as the information accumulation apparatus 201. The case has been described where the information processing apparatus 100 is an apparatus different from the client apparatus 202. However, the configuration is not limited to this. For example, there may be a case where the information processing apparatus 100 has the functions of the client apparatus 202 and operates also as the client apparatus 202.

### Application Example of Information Processing Apparatus 100

An application example of the information processing apparatus 100 will be described next. For example, the information processing apparatus 100 may be applied for the purpose of managing a plurality of new and old files. For example, the information processing apparatus 100 may be applied for the purpose of managing which file is new and which file is old among the plurality of files. For example, the information processing apparatus 100 may appropriately update an order relationship between the plurality of files in response to creation or update of a file. For example, the information processing apparatus 100 may achieve reductions in the processing load and the processing time for updating the order relationship between the plurality of files. For example, the information processing apparatus 100 may achieve reductions in the processing load and the processing time for determining which file is a new file among two different files.

### Example of Hardware Configuration of Information Processing Apparatus 100

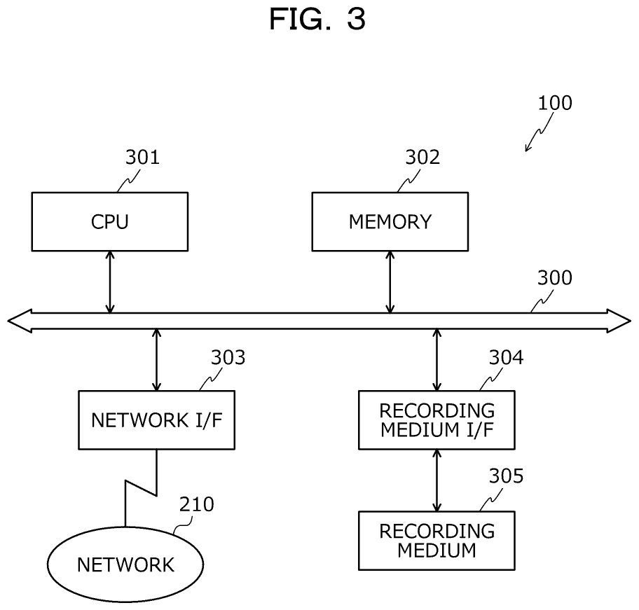

An example of a hardware configuration of the information processing apparatus 100 will be described next by using FIG. 3.

FIG. 3 is a block diagram illustrating an example of a hardware configuration of the information processing apparatus 100. In FIG. 3, the information processing apparatus 100 includes a central processing unit (CPU) 301, a memory 302, a network interface (I/F) 303, a recording medium I/F 304, and a recording medium 305. The individual components are coupled to each other by a bus 300.

The CPU 301 controls the entire information processing apparatus 100. The memory 302 includes, for example, a read-only memory (ROM), a random-access memory (RAM), a flash ROM, and the like. For example, the flash ROM or the ROM stores various programs, and the RAM is used as a work area of the CPU 301. The programs stored in the memory 302 are loaded by the CPU 301, and thus cause the CPU 301 to execute coded processing.

The network I/F 303 is coupled to the network 210 through a communication line, and is coupled to another computer via the network 210. The network I/F 303 manages an interface between the network 210 and an internal interface, and controls input and output of data from the another computer. The network I/F 303 is, for example, a modem, a LAN adapter, or the like.

The recording medium I/F 304 controls reading and writing of data from and to the recording medium 305 in accordance with control of the CPU 301. The recording medium I/F 304 is, for example, a disk drive, a solid-state drive (SSD), a Universal Serial Bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be removably attached to the information processing apparatus 100.

In addition to the components described above, the information processing apparatus 100 may include a keyboard, a mouse, a display, a printer, a scanner, a microphone, a speaker, or the like, for example. The information processing apparatus 100 may include a plurality of recording medium I/Fs 304 and a plurality of recording media 305. The information processing apparatus 100 does not have to include the recording medium I/F 304 or the recording medium 305.

### Example of Hardware Configuration of Information Accumulation Apparatus 201

For example, an example of a hardware configuration of the information accumulation apparatus 201 is substantially the same as the example of the hardware configuration of the information processing apparatus 100 illustrated in FIG. 3, and thus description thereof is omitted.

### Example of Hardware Configuration of Client Apparatus 202

For example, an example of a hardware configuration of the client apparatus 202 is substantially the same as the example of the hardware configuration of the information processing apparatus 100 illustrated in FIG. 3, and thus description thereof is omitted.

### Example of Functional Configuration of Information Processing Apparatus 100

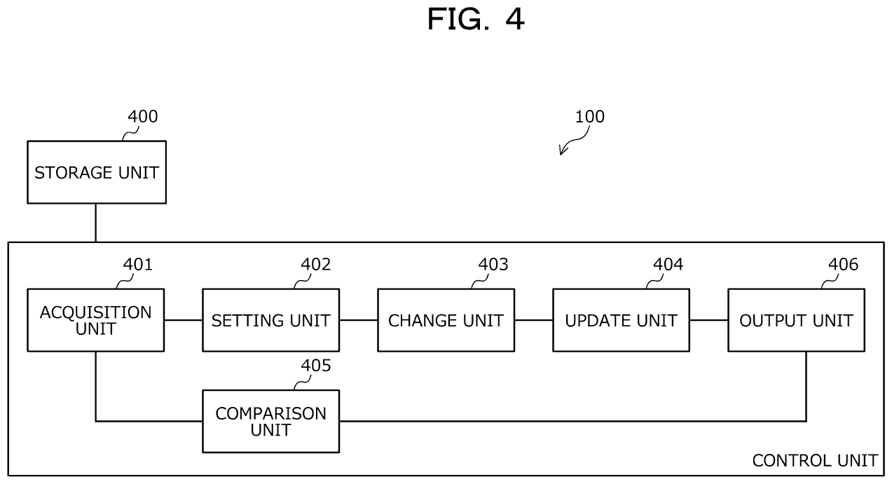

An example of a functional configuration of the information processing apparatus 100 will be described next by using FIG. 4.

FIG. 4 is a block diagram illustrating an example of the functional configuration of the information processing apparatus 100. The information processing apparatus 100 includes a storage unit 400, an acquisition unit 401, a setting unit 402, a change unit 403, an update unit 404, a comparison unit 405, and an output unit 406.

The storage unit 400 is implemented by, for example, a storage area of the memory 302, the recording medium 305, or the like illustrated in FIG. 3. A case will be described below where the storage unit 400 is included in the information processing apparatus 100. However, the configuration is not limited to this. For example, there may be a case where the storage unit 400 is included in an apparatus different from the information processing apparatus 100 and content stored in the storage unit 400 may be referred to from the information processing apparatus 100.

The acquisition unit 401 to the output unit 406 function as an example of a control unit. For example, functions of the acquisition unit 401 to the output unit 406 are implemented by causing the CPU 301 to execute a program stored in a storage area of the memory 302, the recording medium 305, or the like illustrated in FIG. 3, or by using the network I/F 303. For example, a processing result of each functional unit is stored in the storage area of the memory 302, the recording medium 305, or the like illustrated in FIG. 3.

The storage unit 400 stores various kinds of information to be referred to or updated in processing performed by each functional unit. For example, the storage unit 400 stores a data group. For example, the data group is set in advance by a user. For example, the data group may be acquired by the acquisition unit 401.

For example, the storage unit 400 stores, in order, a plurality of pieces of value data that are associated with respective different pieces of data included in the data group. For example, the pieces of value data represent values of a predetermined number of digits with which as many values as a constant multiple of the number of pieces of data included in the data group are representable. For example, the predetermined number of digits is (log N+x). N is the number of pieces of data included in the data group. For example, x is 3.

The values of the predetermined number of digits are, for example, any values from “0000 . . . 0” to “1111 . . . 1”. For example, among the values of the predetermined number of digits, values of lower log N bits may represent the number of pieces of data included in the data group. For example, among the values of the predetermined number of digits, values of the upper 3 bits may take eight values. Accordingly, the values of the predetermined number of digits may represent eight times as many values as the number of pieces of data included in the data group. For example, the storage unit 400 stores each piece of value data of the plurality of pieces of value data as a component of an array in which components may be coupled to each other by pointers.

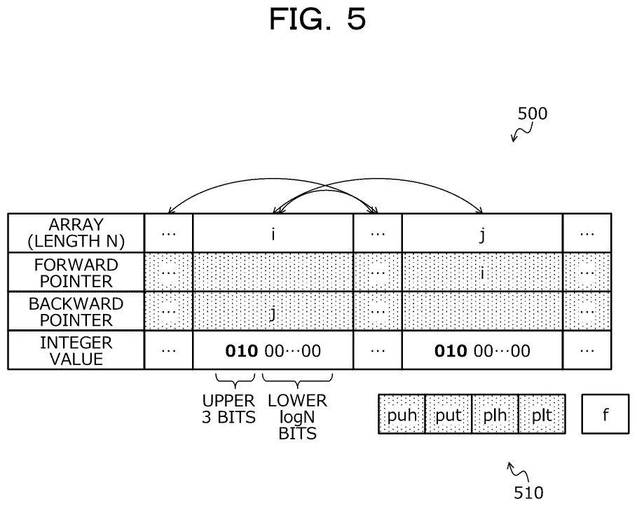

For example, the storage unit 400 stores array information 500 described later in FIG. 5. For example, the pieces of value data are set in advance by a user. For example, the pieces of value data may be generated by the acquisition unit 401, based on the number of pieces of data included in the data group. For example, an order of value data to which a value that belongs to a certain range among a plurality of ranges is set is treated as an order before an order of value data to which a value that belongs to a lower range lower than this certain range is set. For example, an order of value data to which a certain first value that belongs to a certain range is set is treated as an order before an order of value data to which a second value that is smaller than the first value and that belongs to this certain range is set.

The storage unit 400 stores a plurality of ranges that are set for the values of the predetermined number of digits and in each of which the at least the number of pieces of data is representable. For example, the plurality of ranges are set in advance. For example, the plurality of ranges include a first range and a second range. For example, the plurality of ranges may include a third range and a fourth range. For example, the third range and the fourth range are lower than the first range and the second range. For example, the first range is a range from “1100 . . . 0” to “1111 . . . 1”. For example, the second range is a range from “1000 . . . 0” to “1011 . . . 1”. For example, the third range is a range from “0100 . . . 0” to “0111 . . . 1”. For example, the fourth range is a range from “0000 . . . 0” to “0011 . . . 1”.

The storage unit 400 stores flag information. For example, the flag information defines an upper-lower relationship between the first range and the second range among the plurality of ranges. For example, the flag information defines an upper-lower relationship between the third range and the fourth range among the plurality of ranges. For example, the flag information defines an upper-lower relationship between the first range and the second range and an upper-lower relationship between the third range and the fourth range among the plurality of ranges. For example, when the value of the flag information is 0, the flag information indicates that the first range is treated as being upper than the second range and that the third range is treated as being upper than the fourth range. For example, when the value of the flag information is 1, the flag information indicates that the second range is treated as being upper than the first range and that the fourth range is treated as being upper than the third range. For example, the flag information is set to 0 in an initial state.

The acquisition unit 401 acquires various kinds of information for use in processing performed by each functional unit. The acquisition unit 401 stores the acquired various kinds of information in the storage unit 400 or outputs the acquired various kinds of information to each functional unit. The acquisition unit 401 may output the various kinds of information stored in the storage unit 400 to the each functional unit. For example, the acquisition unit 401 acquires the various kinds of information, based on an input operation of a user. For example, the acquisition unit 401 may receive the various kinds of information from an apparatus different from the information processing apparatus 100.

The acquisition unit 401 acquires the data group. For example, the acquisition unit 401 acquires the data group by accepting an input of the data group based on an input operation of the user. For example, the acquisition unit 401 may acquire the data group by receiving the data group from another computer.

The acquisition unit 401 acquires a plurality of pieces of value data. For example, the acquisition unit 401 acquires the plurality of pieces of value data by generating the plurality of pieces of value data, based on the number of pieces of data included in the data group.

The acquisition unit 401 accepts designation of first value data to be moved to a head in the order among the plurality of pieces of value data. For example, the acquisition unit 401 accepts designation of the first value data to be moved to the head in the order, based on an input operation of the user. For example, the acquisition unit 401 may accept designation of the first value data to be moved to the head in the order by receiving, from another computer, a notification including the designation of the first value data to be moved to the head in the order.

The acquisition unit 401 accepts designation of second value data to be moved to a tail in the order among the plurality of pieces of value data. For example, the acquisition unit 401 accepts designation of the second value data to be moved to the tail in the order, based on an input operation of the user. For example, the acquisition unit 401 may accept designation of the second value data to be moved to the tail in the order by receiving, from another computer, a notification including the designation of the second value data to be moved to the tail in the order.

The acquisition unit 401 acquires a determination request to determine an order relationship between two pieces of data in the data group. For example, the determination request includes designation of the two pieces of data in the data group. The determination request may include designation of pieces of value data associated with the respective two pieces of data in the data group. For example, the acquisition unit 401 acquires the determination request by accepting input of the determination request, based on an input operation of the user. For example, the acquisition unit 401 may acquire the determination request by receiving the determination request from another computer.

The acquisition unit 401 may accept a start trigger for starting processing of any functional unit. For example, the start trigger is a predetermined input operation by the user. For example, the start trigger may be reception of predetermined information from another computer. For example, the start trigger may be output of predetermined information by any functional unit.

For example, the acquisition unit 401 may accept acquisition of the plurality of pieces of value data, as a start trigger for starting processing of the setting unit 402. For example, the acquisition unit 401 may accept acceptance of designation of the first value data, as a start trigger for starting processing of the change unit 403 and the update unit 404. For example, the acquisition unit 401 may accept acceptance of designation of the second value data, as a start trigger for starting processing of the change unit 403 and the update unit 404. The acquisition unit 401 may accept acquisition of the determination request, as a start trigger for starting processing of the comparison unit 405.

The setting unit 402 sets, with reference to the flag information, a value that belongs to a lower range among the first range and the second range to each piece of value data of the plurality of pieces of value data. For example, the setting unit 402 identifies the lower range among the first range and the second range with reference to the flag information. For example, the setting unit 402 sets the same value that belongs to the identified lower range to each piece of value data of the plurality of pieces of value data. Accordingly, the setting unit 402 may initialize the plurality of pieces of value data, and may use the plurality of pieces of value data for the purpose of managing an order relationship between pieces of data included in the data group.

The setting unit 402 sets, with reference to the flag information, a value that belongs to the lower range among the first range and the second range or a value that belongs to the upper range among the third range and the fourth range to each piece of value data of the plurality of pieces of value data. For example, the setting unit 402 identifies the lower range among the first range and the second range or the upper range among the third range and the fourth range with reference to the flag information. For example, the setting unit 402 sets the same value that belongs to the identified lower range among the first range and the second range or the same value that belongs to the identified upper range among the third range and the fourth range to each piece of value data of the plurality of pieces of value data. Accordingly, the setting unit 402 may initialize the plurality of pieces of value data, and may use the plurality of pieces of value data for the purpose of managing an order relationship between pieces of data included in the data group.

The setting unit 402 identifies, with reference to the flag information, fifth value data that is first in the order among a piece of value data to which a value that belongs to the lower range among the first range and the second range has been set and a piece of value data to which a value that belongs to the upper range among the third range and the fourth range has been set. The setting unit 402 may set a value that belongs to the upper range among the first range and the second range to the identified fifth value data. For example, after the update unit 404 updates the flag information, the setting unit 402 identifies the fifth value data that is the first in the order, and sets a value that belongs to the upper range among the first range and the second range. Accordingly, the setting unit 402 may secure the value data to which a value that belongs to the upper range among the first range and the second range is set.

The setting unit 402 identifies, with reference to the flag information, sixth value data that is last in the order among a piece of value data to which a value that belongs to the lower range among the first range and the second range has been set and a piece of value data to which a value that belongs to the upper range among the third range and the fourth range has been set. The setting unit 402 may set a value that belongs to the lower range among the third range and the fourth range to the identified sixth value data. For example, after the update unit 404 updates the flag information, the setting unit 402 identifies the sixth value data that is the last in the order, and sets a value that belongs to the lower range among the third range and the fourth range. Accordingly, the setting unit 402 may secure the value data to which a value that belongs to the lower range among the third range and the fourth range is set.

Each time designation of the first value data to be moved to the head in the order is accepted, the change unit 403 identifies the upper range and the lower range among the first range and the second range with reference to the flag information. Each time designation of the first value data is accepted, the change unit 403 sets a value that belongs to the identified upper range among the first range and the second range to the first value data such that the first value data is before the other pieces of value data in the order. Accordingly, the change unit 403 may indicate the order of data associated with the first value data in the data group by the order of the first value data, and may enable the order relationship between pieces of data included in the data group to be appropriately represented.

At this time, the change unit 403 may identify the upper range and the lower range among the third range and the fourth range with reference to the flag information. The change unit 403 may identify third value data that is the last in the order among a piece of value data to which a value that belongs to the lower range among the first range and the second range has been set and a piece of value data to which a value that belongs to the upper range among the third range and the fourth range has been set. The change unit 403 may set a value that belongs to the lower range among the third range and the fourth range to the identified third value data. Accordingly, the change unit 403 may reduce the number of pieces of value data included in the pieces of value data to which values that belong to the lower range among the first range and the second range have been set and the pieces of value data to which values that belong to the upper range among the third range and the fourth range have been set.

Each time designation of the second value data to be moved to the tail in the order is accepted, the change unit 403 identifies the upper range and the lower range among the third range and the fourth range with reference to the flag information. Each time designation of the second value data is accepted, the change unit 403 sets a value that belongs to the identified lower range among the third range and the fourth range to the second value data such that the second value data is after the other pieces of value data in the order. Accordingly, the change unit 403 may indicate the order of data associated with the second value data in the data group by the order of the second value data, and may enable the order relationship between pieces of data included in the data group to be appropriately represented.

At this time, the change unit 403 may identify the upper range and the lower range among the first range and the second range with reference to the flag information. The change unit 403 may identify fourth value data that is the first in the order among a piece of value data to which a value that belongs to the lower range among the first range and the second range has been set and a piece of value data to which a value that belongs to the upper range among the third range and the fourth range has been set. The change unit 403 sets a value that belongs to the upper range among the first range and the second range to the identified fourth value data. Accordingly, the change unit 403 may reduce the number of pieces of value data included in the pieces of value data to which values that belong to the lower range among the first range and the second range have been set and the pieces of value data to which values that belong to the upper range among the third range and the fourth range have been set.

The update unit 404 detects a piece of value data to which a value that belongs to the lower range has been set no longer existing among the plurality of pieces of value data. In response to the detection, the update unit 404 updates the flag information such that the upper-lower relationship between the first range and the second range is switched. Accordingly, the update unit 404 may update the flag information such that a piece of value data to which a value that belongs to the upper range among the first range and the second range is set no longer exists. The update unit 404 may accept designation of the first value data again and may enable the update of the plurality of pieces of value data.

The update unit 404 detects, with reference to the flag information, a piece of value data to which a value that belongs to the lower range among the first range and the second range has been set no longer existing and a piece of value data to which a value that belongs to the upper range among the third range and the fourth range has been set no longer existing. In response to the detection, the update unit 404 updates the flag information such that the upper-lower relationship between the first range and the second range is switched and the upper-lower relationship between the third range and the fourth range is switched. Accordingly, the update unit 404 may update the flag information such that a piece of value data to which a value that belongs to the lower range among the third range and the fourth range is set no longer exists. The update unit 404 may accept designation of the second value data again and may enable the update of the plurality of pieces of value data.

In response to acceptance of the determination request, the comparison unit 405 determines an order relationship between two pieces of data in the data group. For example, the comparison unit 405 compares values set to the pieces of value data associated with the respective two pieces of data. For example, the comparison unit 405 determines that the order of one piece of data associated with the value data to which a larger value is set among the two pieces of data is an order before the order of the other piece of data. Accordingly, the comparison unit 405 may appropriately determine the order relationship between the two pieces of data. The comparison unit 405 may achieve reductions in the processing load and the processing time for determining the order relationship between two pieces of data.

The output unit 406 outputs a processing result of at least any functional unit. For example, an output form is display on a display, output to a printer for printing, transmission to an external apparatus through the network I/F 303, or storage in a storage area of the memory 302, the recording medium 305, or the like. Accordingly, the output unit 406 may allow a user to be notified of the processing result of at least any functional unit, and achieve improvement in the convenience of the information processing apparatus 100.

For example, the output unit 406 outputs the plurality of pieces of value data. For example, the output unit 406 outputs the plurality of pieces of value data to be referred to by the user. Accordingly, the output unit 406 allows the user to use the plurality of pieces of value data.

For example, the output unit 406 outputs a result of determining the order relationship between two pieces of data in the data group. For example, the output unit 406 outputs a result of determining the order relationship between two pieces of data in the data group to be referred to by the user. Accordingly, the output unit 406 allows the user to grasp the order relationship between the two pieces of data.

### Example of Operation of Information Processing Apparatus 100

An example of an operation of the information processing apparatus 100 will be described next by using FIGS. 5 to 16. An example in which the information processing apparatus 100 stores the array information 500 will be described first by using FIG. 5.

FIG. 5 is an explanatory diagram illustrating an example of storing the array information 500. In FIG. 5, the information processing apparatus 100 stores the array information 500. The array information 500 is implemented by a storage area of the memory 302, the recording medium 305, or the like of the information processing apparatus 100 illustrated in FIG. 3, for example.

The array information 500 includes fields of an array, a forward pointer, a backward pointer, and an integer value. By setting information in each of the fields for each element of an array, N pieces of element information are stored as respective records in the array information 500.

In the field of the array, elements of the array are set. There are N elements of the array. In the field of the forward pointer, an index of another element existing immediately before the element of the aforementioned array is set. In the field of the backward pointer, an index of another element existing immediately after the element of the aforementioned array is set. In the field of the integer value, an integer value serving as a counter associated with the element of the aforementioned array is set. The integer value is information for managing the order of the element of the aforementioned array. The integer value is a value of the number of digits (log N+3).

For example, an upper range, an intermediate range 1, an intermediate range 2, and a lower range are set for the integer value. As the upper range, for example, a first range from “1111 . . . 1” to “1100 . . . 0” is set in the initial state. As the intermediate range 1, for example, a second range from “1011 . . . 1” to “1000 . . . 0” is set in the initial state. For example, there is a case where the ranges set as the upper range and the intermediate range 1 are switched and the second range from “1011 . . . 1” to “1000 . . . 0” is set as the upper range.

As the intermediate range 2, for example, a third range from “0111 . . . 1” to “0100 . . . 0” is set in the initial state. As the lower range, for example, a fourth range from “0011 . . . 1” to “0000 . . . 0” is set in the initial state. For example, there is a case where the ranges set as the intermediate range 2 and the lower range are switched, and the third range from “0111 . . . 1” to “0100 . . . 0” is set as the lower range.

The order of an element corresponding to an integer value that belongs to the upper range is treated as an order before the order of an element corresponding to an integer value that belongs to the intermediate range 1. The order of an element corresponding to an integer value that belongs to the intermediate range 1 is treated as an order before the order of an element corresponding to an integer value that belongs to the intermediate range 2. The order of an element corresponding to an integer value that belongs to the intermediate range 2 is treated as an order before the order of an element corresponding to an integer value that belongs to the lower range.

The order of an element corresponding to a first integer value that belongs to the upper range is treated as an order before the order of an element corresponding to a second integer value that is smaller than the first integer value and belongs to the same upper range. The order of an element corresponding to a first integer value that belongs to the intermediate range 1 is treated as an order before the order of an element corresponding to a second integer value that is smaller than the first integer value and belongs to the same intermediate range 1.

The order of an element corresponding to a first integer value that belongs to the intermediate range 2 is treated as an order before the order of an element corresponding to a second integer value that is smaller than the first integer value and belongs to the same intermediate range 2. The order of an element corresponding to a first integer value that belongs to the lower range is treated as an order before the order of an element corresponding to a second integer value that is smaller than the first integer value and belongs to the same lower range.

The information processing apparatus 100 stores range pointers 510. The range pointers are puh, put, plh, and plt. “puh” is a pointer that enables identification of a head element among elements corresponding to integer values that belong to the upper range. “puh” represents an integer value corresponding to the head element among the elements corresponding to the integer values that belong to the upper range. “put” is a pointer that enables identification of a tail element among elements corresponding to integer values that belong to the upper range. “put” represents an integer value corresponding to the tail element among the elements corresponding to the integer values that belong to the upper range.

“plh” is a pointer that enables identification of a head element among elements corresponding to integer values that belong to the lower range. “plh” represents an integer value corresponding to the head element among the elements corresponding to the integer values that belong to the lower range. “plt” is a pointer that enables identification of a tail element among elements corresponding to integer values that belong to the lower range. “plt” represents an integer value corresponding to the tail element among the elements corresponding to the integer values that belong to the lower range.

The information processing apparatus 100 stores flag information f. The flag information f is information for managing which ranges are to be set as the upper range and the intermediate range 1 and which ranges are to be set as the intermediate range 2 and the lower range.

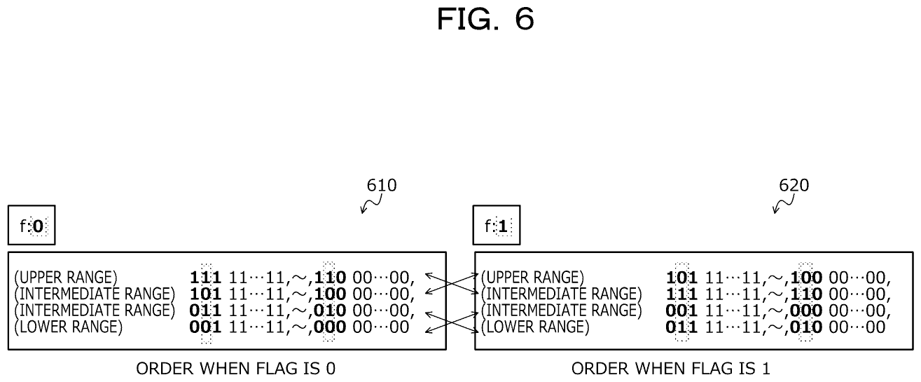

An example of relationships between the flag information and the various ranges will be described next by using FIG. 6. The various ranges are, for example, the upper range, the intermediate range 1, the intermediate range 2, and the lower range.

FIG. 6 is an explanatory diagram illustrating an example of the relationships between the flag information and the various ranges. As indicated by a reference sign 610 in FIG. 6, for example, if the value of the flag information f is 0, the flag information f indicates that the first range is set as the upper range, the second range is set as the intermediate range 1, the third range is set as the intermediate range 2, and the fourth range is set as the lower range.

For example, as indicated by a reference sign 620 in FIG. 6, if the value of the flag information f is 1, the flag information f indicates that the second range is set as the upper range, the first range is set as the intermediate range 1, the fourth range is set as the intermediate range 2, and the third range is set as the lower range. As described above, the information processing apparatus 100 may switch the orders of the first range and the second range and the orders of the third range and the fourth range by using the flag information f.

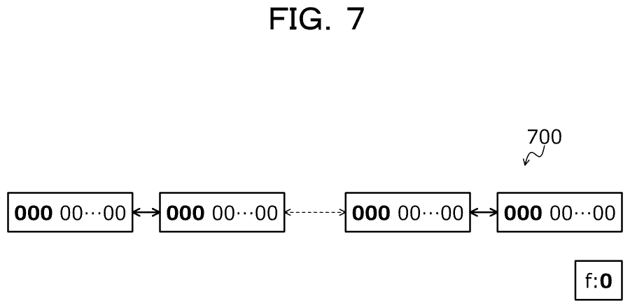

An example in which the information processing apparatus 100 manages orders of elements of an array will be described next by using FIGS. 7 to 14.

FIGS. 7 to 14 are explanatory diagrams illustrating an example of managing orders of elements of an array. In FIG. 7, as indicated by a reference sign 700, the information processing apparatus 100 initializes integer values serving as counters corresponding to all elements of the array to “000 00 . . . 00”. The reference sign 700 in FIG. 7 indicates coupling relationships between the elements and the integer values corresponding to the respective elements at the time of initialization.

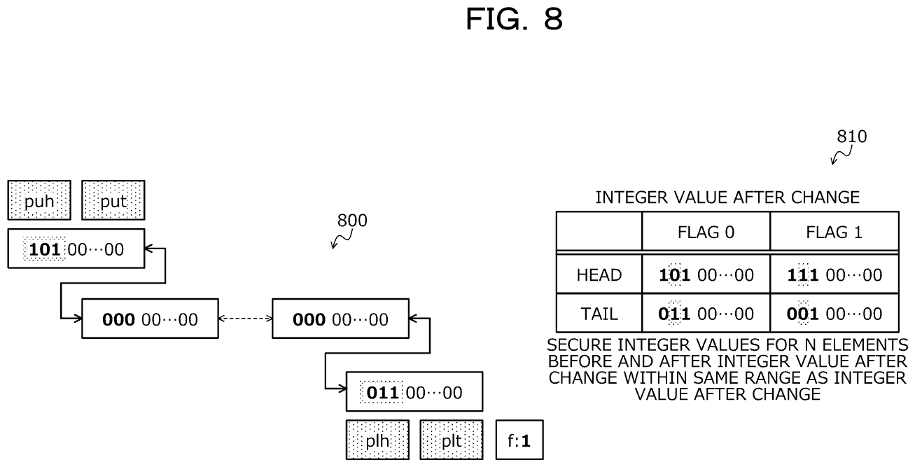

As indicated by the reference sign 700, the information processing apparatus 100 sets the flag information f to O. Accordingly, the information processing apparatus 100 may initialize the array information 500, and may start managing the order relationship between the elements of the array. The description proceeds to description of FIG. 8 next.

In FIG. 8, as indicated by a reference sign 800, the information processing apparatus 100 updates the integer value corresponding to the head element among all the elements of the array. The reference sign 800 in FIG. 8 indicates the coupling relationships between elements and the integer values corresponding to the respective elements after the update.

For example, if the flag information f is 0, the information processing apparatus 100 sets “101 00 . . . 00” as the integer value corresponding to the head element in accordance with a table 810. For example, if the flag information f is 1, the information processing apparatus 100 sets “111 00 . . . 00” as the integer value corresponding to the head element in accordance with the table 810. For example, in the example illustrated in FIG. 8, the information processing apparatus 100 sets “101 00 . . . 00” as the integer value corresponding to the head element.

As indicated by the reference sign 800, the information processing apparatus 100 updates the integer value corresponding to the tail element among all the elements of the array. For example, if the flag information f is 0, the information processing apparatus 100 sets “011 00 . . . 00” as the integer value corresponding to the tail element in accordance with the table 810. For example, if the flag information f is 1, the information processing apparatus 100 sets “001 00 . . . 00” as the integer value corresponding to the tail element in accordance with the table 810. For example, in the example illustrated in FIG. 8, the information processing apparatus 100 sets “011 00 . . . 00” as the integer value corresponding to the tail element.

The information processing apparatus 100 inverts the flag information f. In the example of FIG. 8, for example, the information processing apparatus 100 sets the flag information f to 1. The information processing apparatus 100 sets the integer value “101 00 . . . 00” corresponding to the head element to “puh” and “put”. The information processing apparatus 100 sets the integer value “011 00 . . . 00” corresponding to the tail element to “plh” and “plt”.

Accordingly, the information processing apparatus 100 may cause the head element to belong to the upper range. Within the upper range, the information processing apparatus 100 may secure unused integer values for N elements before and after the integer value corresponding to the head element. Thus, the information processing apparatus 100 may enable management of, in addition to the head element, up to N other elements as elements whose order is before the order of the head element. Likewise, the information processing apparatus 100 may enable management of, in addition to the head element, up to N other elements as elements whose order is after the order of the head element. Accordingly, the information processing apparatus 100 may secure unused integer values, and may appropriately manage the order relationship between all the elements of the array.

Likewise, the information processing apparatus 100 may cause the tail element to belong to the lower range. Within the lower range, the information processing apparatus 100 may secure unused integer values for N elements before and after the integer value corresponding to the tail element. Thus, the information processing apparatus 100 may enable management of, in addition to the tail element, up to N other elements as elements whose order is before the order of the tail element. Likewise, the information processing apparatus 100 may enable management of, in addition to the tail element, up to N other elements as elements whose order is after the order of the tail element. Accordingly, the information processing apparatus 100 may secure unused integer values, and may appropriately manage the order relationship between all the elements of the array.

The case has been described in which the information processing apparatus 100 updates the integer value corresponding to the head element, updates the integer value corresponding to the tail element, and then inverts the flag information f. However, the configuration is not limited to this. For example, there may be a case where the information processing apparatus 100 inverts the flag information f, and then updates the integer value corresponding to the head element and updates the integer value corresponding to the tail element.

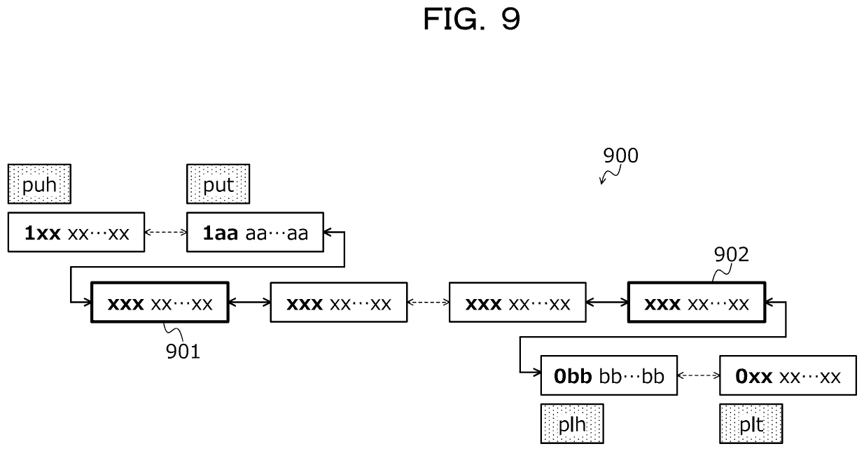

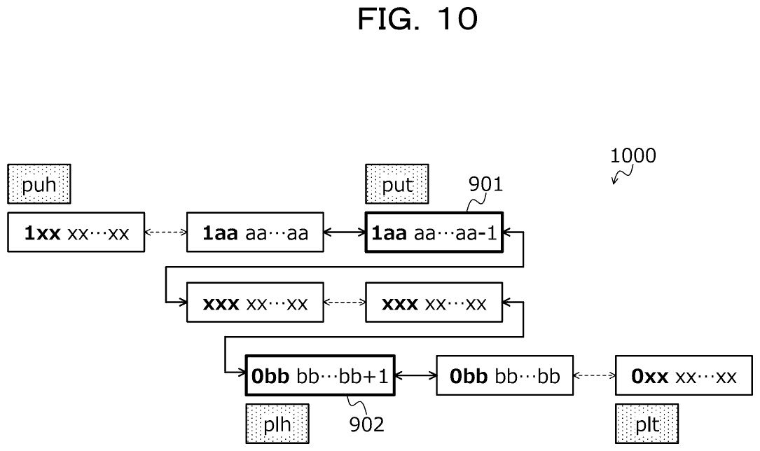

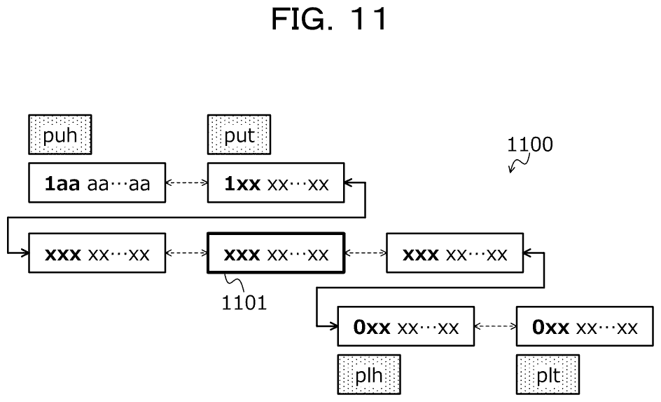

Various kinds of processing to be performed by the information processing apparatus 100 when accepting a move query for requesting movement of any element to the head or the tail in the order will be described next by using FIGS. 9 to 14. For example, the various kinds of processing include an averaging movement processing described later by using to FIGS. 9 and 10. For example, the various kinds of processing include order change processing described later with reference to FIGS. 11 to 14. The description proceeds first to description of FIGS. 9 and 10.

In FIG. 9, the information processing apparatus 100 performs averaging movement in response to accepting a move query for requesting movement of any element to the head or the tail in the order. The averaging movement is moving any element that belongs to the intermediate range 1 or the intermediate range 2 such that the element belongs to the upper range and moving any element that belongs to the intermediate range 1 or the intermediate range 2 such that the element belongs to the lower range.

A reference sign 900 in FIG. 9 indicates coupling relationships between elements and integer values corresponding to the respective elements at a certain timing. As indicated by the reference sign 900, the information processing apparatus 100 identifies a head element 901 among the elements that belong to the intermediate range 1 and the elements that belong to the intermediate range 2, and identifies an integer value corresponding to the head element 901. As indicated by the reference sign 900, the information processing apparatus 100 identifies a tail element 902 among the elements that belong to the intermediate range 1 and the elements that belong to the intermediate range 2, and identifies an integer value corresponding to the tail element 902. The description proceeds next to description of FIG. 10.

In FIG. 10, the information processing apparatus 100 moves the identified head element 901 among the elements that belong to the intermediate range 1 and the elements that belong to the intermediate range 2 such that the identified head element 901 belongs to the upper range. For example, as indicated by a reference sign 1000, the information processing apparatus 100 sets “puh-1” to the integer value corresponding to the identified head element 901 among the elements that belong to the intermediate range 1 and the elements that belong to the intermediate range 2, and sets this set integer value to “put”. The reference sign 1000 in FIG. 10 indicates coupling relationships between elements and the integer values corresponding to the respective elements after the averaging movement processing is performed.

The information processing apparatus 100 moves the identified tail element 902 among the elements that belong to the intermediate range 1 and the elements that belong to the intermediate range 2 such that the identified tail element 902 belongs to the lower range. For example, as indicated by the reference sign 1000, the information processing apparatus 100 sets “plt+1” to the integer value corresponding to the identified tail element 902 among the elements that belong to the intermediate range 1 and the elements that belong to the intermediate range 2, and sets the set integer value as “plh”.

Accordingly, the information processing apparatus 100 may ensure that the number of elements that belong to the intermediate range 1 and elements that belong to the intermediate range 2 is reduced by at least one for each move query. The information processing apparatus 100 may ensure that there is at least one or more elements in the upper range and that there is at least one or more elements in the lower range before and after the move query. Thus, the information processing apparatus 100 may suppress a processing error. The description proceeds next to description of FIG. 11.

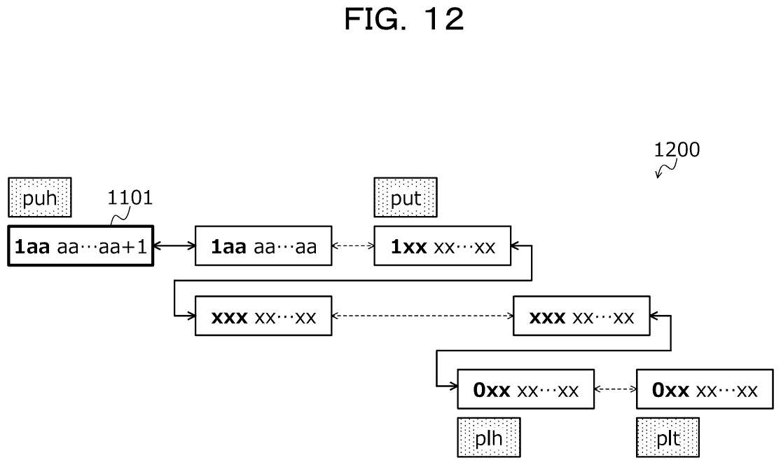

In FIG. 11, as indicated by a reference sign 1100, it is assumed that the information processing apparatus 100 has accepted a move query for requesting movement of an element 1101 to the head in the order and has performed the averaging movement processing. The reference sign 1100 in FIG. 11 indicates coupling relationships between elements and integer values corresponding to the respective elements at a certain timing. The description proceeds next to description of FIG. 12.

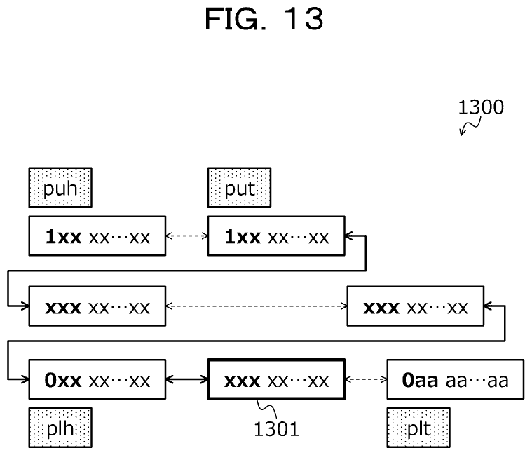

In FIG. 12, as indicated by a reference sign 1200, the information processing apparatus 100 performs the order change processing in response to a move query by setting “puh+1” to an integer value of the element 1101 for which the move query has been accepted and setting this set integer value to “puh”. The reference sign 1200 in FIG. 12 indicates coupling relationships between elements and the integer values corresponding to the respective elements after the order change processing is performed. Accordingly, the information processing apparatus 100 may update the integer value corresponding to the element 1101 and move the element 1101 to the head in the order. The description proceeds next to description of FIG. 13.

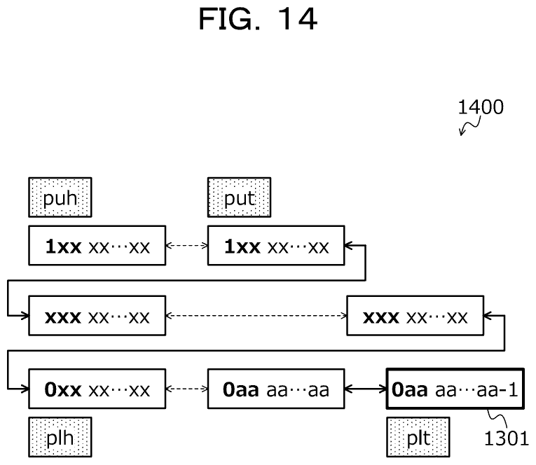

In FIG. 13, as indicated by a reference sign 1300, it is assumed that the information processing apparatus 100 has accepted a move query for requesting movement of an element 1301 to the tail in the order and has performed the averaging movement processing. The reference sign 1300 in FIG. 13 indicates coupling relationships between elements and integer values corresponding to the respective elements at a certain timing. The description proceeds next to description of FIG. 14.

In FIG. 14, as indicated by a reference sign 1400, the information processing apparatus 100 performs the order change processing in response to a move query by setting “plt−1” to an integer value of the element 1301 for which the move query has been accepted and setting this set integer value to “plt”. The reference sign 1400 in FIG. 14 indicates coupling relationships between elements and integer values corresponding to the respective elements after the order change processing is performed. Accordingly, the information processing apparatus 100 may update the integer value corresponding to the element 1301 and move the element 1301 to the tail in the order. As described above, the information processing apparatus 100 may represent the order of the element by using the integer value corresponding to this element.

When the element that belongs to the intermediate range 1 and the element that belongs to the intermediate range 2 no longer exist as a result of the averaging movement processing or the order change processing, the information processing apparatus 100 performs the processing illustrated in FIG. 8. For example, as in FIG. 8, the information processing apparatus 100 updates the integer value corresponding to the head element, updates the integer value corresponding to the tail element, and then inverts the flag information f.

Accordingly, the information processing apparatus 100 may reuse the ranges of values settable as the integer values. The information processing apparatus 100 may enable the averaging movement processing illustrated in FIGS. 9 and 10 and the order change processing illustrated in FIGS. 11 to 14 to be performed again. Thus, the information processing apparatus 100 may suppress exhaustion of values settable as integer values, and may continue to appropriately manage the order relationship between elements.

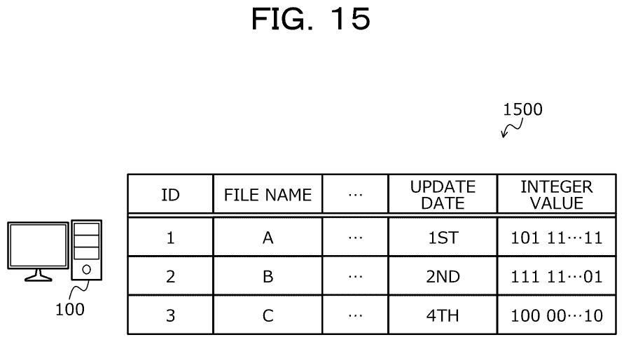

A specific example in which the information processing apparatus 100 manages files will be described next by using FIG. 15.

FIG. 15 is an explanatory diagram illustrating a specific example of managing files. In FIG. 15, the information processing apparatus 100 stores a file management table 1500. For example, the file management table 1500 is implemented by a storage area of the memory 302, the recording medium 305, or the like of the information processing apparatus 100 illustrated in FIG. 3.

The file management table 1500 has fields of an ID, a file name, an update date, and an integer value. By setting information in each field for each file, the file management table 1500 stores file management information as each record.

In the field of the ID, an ID for identifying a file is set. In the field of the file name, a name of the aforementioned file is set. In the field of the update date, an update date of the aforementioned file is set. When the aforementioned file is managed as an element of an array as in the above-described operation example, an integer value corresponding to the element is set in the field of the integer value.

Accordingly, the information processing apparatus 100 may be used for the purpose of managing the order of files. Even in a situation where overflow of the value of the update date occurs, the information processing apparatus 100 may continue to appropriately manage the order of the files.

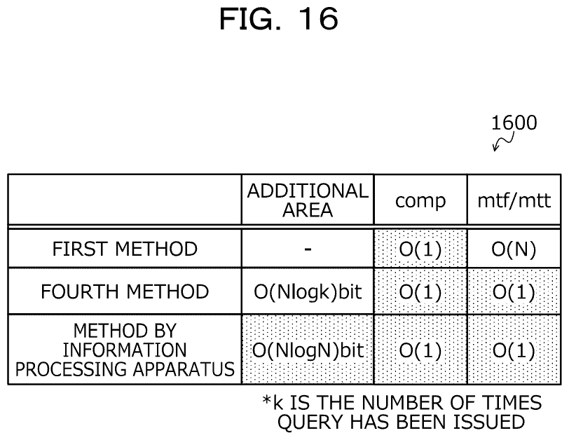

An example of an effect produced by the information processing apparatus 100 will be described next by using FIG. 16.

FIG. 16 is an explanatory diagram illustrating an example of the effect produced by the information processing apparatus 100. FIG. 16 compares the first method described above, the fourth method described above, and the method of the information processing apparatus 100 described in the operation example. The first method is a method in which an order relationship between pieces of data included in a plurality of pieces of data is managed by setting each piece of data of the plurality of pieces of data as a component of an array. The fourth method is a method in which a counter value is prepared and an order relationship between pieces of data included in a plurality of pieces of data is managed by using the counter value.

In the first method, a processing load and a processing time for the “movement processing (mtf/mtt)” become a magnitude of O(N). In contrast, in the method of the information processing apparatus 100, the processing load and the processing time for the “movement processing (mtf/mtt)” may be suppressed to a magnitude of O(1).

In the fourth method, a counter of O(N log k) bits is prepared to suppress overflow of the counter. “k” is the number of times the move query has been issued. Accordingly, in the fourth method, it is unable to determine a counter of what bits is to be prepared if the number of times the move query has been issued is unknown. In the fourth method, when the move query is continued to be issued, overflow of the counter occurs. Thus, the order relationship between pieces of data may not be appropriately managed.

In contrast, in the method of the information processing apparatus 100, just integer values serving as a counter of O(N log N) bits are prepared. Thus, in the method of the information processing apparatus 100, overflow of the counter may be suppressed even when the move query is continued to be issued, and the order relationship between pieces of data may be appropriately managed.

In the method of the information processing apparatus 100, the processing load and the processing time for the “comparison processing (comp)” may be suppressed to a magnitude of O(1). Accordingly, the information processing apparatus 100 may avoid the occurrence of an inconvenience that the processing load and the processing time for the “comparison processing (comp)” increase as compared with the first method and the fourth method.

### Procedure of Initialization Processing

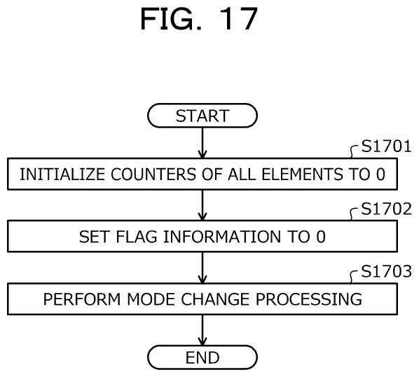

An example of a procedure of an initialization processing performed by the information processing apparatus 100 will be described next by using FIG. 17. For example, the initialization processing is implemented by the CPU 301, a storage area of the memory 302, the recording medium 305, or the like, and the network I/F 303 illustrated in FIG. 3.

FIG. 17 is a flowchart illustrating an example of the procedure of the initialization processing. In FIG. 17, the information processing apparatus 100 initializes counters of all elements to 0 (step S1701). Next, the information processing apparatus 100 sets the flag information to 0 (step S1702). The information processing apparatus 100 then performs a mode change processing (step S1703). Thereafter, the information processing apparatus 100 ends the initialization processing.

### Procedure of Mode Change Processing

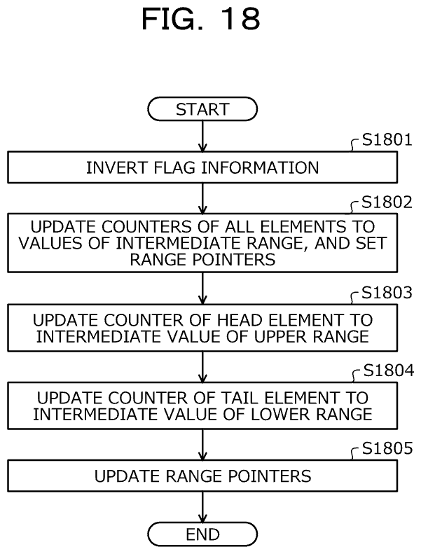

An example of a procedure of the mode change processing performed by the information processing apparatus 100 will be described next by using FIG. 18. For example, the mode change processing is implemented by the CPU 301, a storage area of the memory 302, the recording medium 305, or the like, and the network I/F 303 illustrated in FIG. 3.

FIG. 18 is a flowchart illustrating an example of the procedure of the mode change processing. In FIG. 18, the information processing apparatus 100 inverts the flag information f and changes the mode (step S1801). Next, the information processing apparatus 100 updates the counters of all the elements to values in the intermediate range so that all the elements belong to the intermediate range, and sets the range pointers (step S1802).

Next, the information processing apparatus 100 updates the counter of the head element to an intermediate value of the upper range (step S1803). The information processing apparatus 100 then updates the counter of the tail element to an intermediate value of the lower range (step S1804). Thereafter, the information processing apparatus 100 updates the range pointers (step S1805). The information processing apparatus 100 then ends the mode change processing.

### Procedure of Averaging Movement Processing

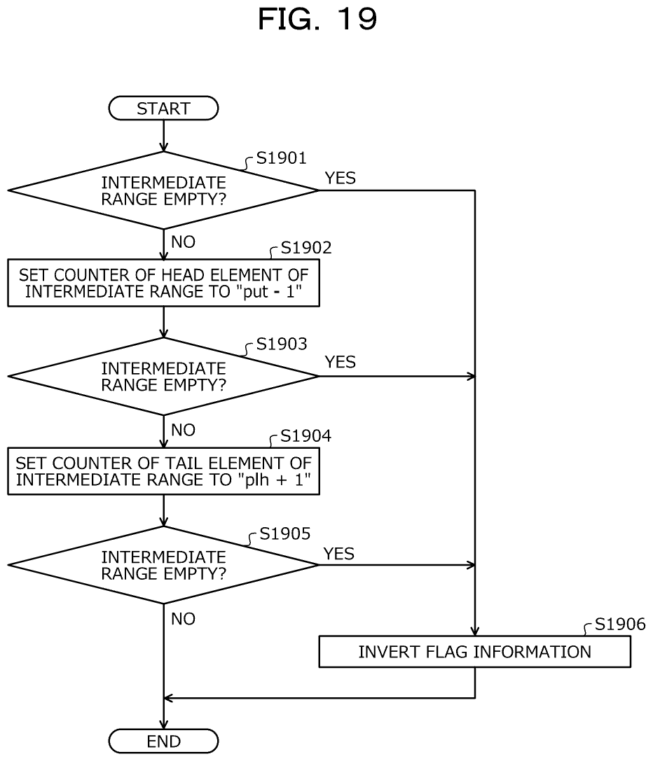

An example of a procedure of the averaging movement processing performed by the information processing apparatus 100 will be described next by using FIG. 19. For example, the averaging movement processing is implemented by the CPU 301, a storage area of the memory 302, the recording medium 305, or the like, and the network I/F 303 illustrated in FIG. 3.

FIG. 19 is a flowchart illustrating an example of the procedure of the averaging movement processing. In FIG. 19, the information processing apparatus 100 determines whether or not the intermediate range is empty (step S1901). If the intermediate range is empty (step S1901: Yes), the information processing apparatus 100 proceeds to processing of step S1906. On the other hand, if the intermediate range is not empty (step S1901: No), the information processing apparatus 100 proceeds to processing of step S1902.

In step S1902, the information processing apparatus 100 sets the counter of the head element of the intermediate range to “put−1” (step S1902). Next, the information processing apparatus 100 determines whether not the intermediate range is empty (step S1903). If the intermediate range is empty (step S1903: Yes), the information processing apparatus 100 proceeds to processing of step S1906. On the other hand, if the intermediate range is not empty (step S1903: No), the information processing apparatus 100 proceeds to processing of step S1904.

In step S1904, the information processing apparatus 100 sets the counter of the tail element of the intermediate range to “plh+1” (step S1904). Next, the information processing apparatus 100 determines whether not the intermediate range is empty (step S1905). If the intermediate range is empty (step S1905: Yes), the information processing apparatus 100 proceeds to processing of step S1906. On the other hand, if the intermediate range is not empty (step S1905: No), the information processing apparatus 100 ends the averaging movement processing.

In step S1906, the information processing apparatus 100 inverts the flag information f and changes the mode (step S1906). The information processing apparatus 100 then ends the averaging movement processing.

### (Procedure of Head Movement Processing)

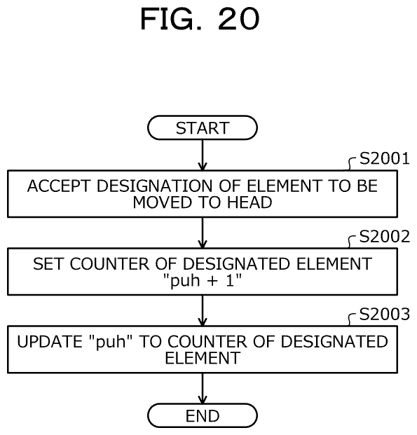

An example of a procedure of head movement processing performed by the information processing apparatus 100 will be described next by using FIG. 20. For example, the head movement processing is implemented by the CPU 301, a storage area of the memory 302, the recording medium 305, or the like, and the network I/F 303 illustrated in FIG. 3.

FIG. 20 is a flowchart illustrating an example of the procedure of the head movement processing. In FIG. 20, the information processing apparatus 100 accepts designation of an element to be moved to the head (step S2001).

Next, the information processing apparatus 100 sets the counter of the designated element to “puh+1” (step S2002). The information processing apparatus 100 then updates “puh” to the counter of the designated element (step S2003). Thereafter, the information processing apparatus 100 ends the head movement processing.

### (Procedure of Tail Movement Processing)

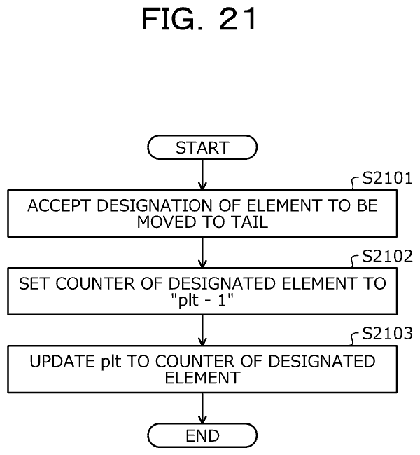

An example of a procedure of tail movement processing performed by the information processing apparatus 100 will be described next by using FIG. 21. For example, the tail movement processing is implemented by the CPU 301, a storage area of the memory 302, the recording medium 305, or the like, and the network I/F 303 illustrated in FIG. 3.

FIG. 21 is a flowchart illustrating an example of the procedure of the tail movement processing. In FIG. 21, the information processing apparatus 100 accepts designation of an element to be moved to the tail (step S2101).

Next, the information processing apparatus 100 sets the counter of the designated element to “plt−1” (step S2102). The information processing apparatus 100 then updates “plt” to the counter of the designated element (step S2103). Thereafter, the information processing apparatus 100 ends the tail movement processing.

### (Procedure of Comparison Processing)

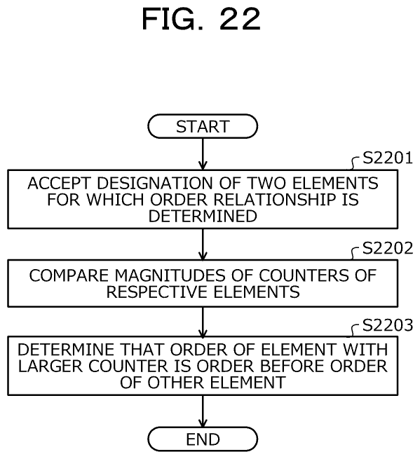

Next, an example of a procedure of comparison processing performed by the information processing apparatus 100 will be described next by using FIG. 22. For example, the comparison processing is implemented by the CPU 301, a storage area of the memory 302, the recording medium 305, or the like, and the network I/F 303 illustrated in FIG. 3.

FIG. 22 is a flowchart illustrating an example of the procedure of the comparison processing. In FIG. 22, the information processing apparatus 100 accepts designation of two elements for which an order relationship is determined (step S2201). Next, the information processing apparatus 100 compares magnitudes of the counters of the two respective designated elements (step S2202).

As a result of the comparison, the information processing apparatus 100 determines that the order of an element having the larger counter among the two elements is an order before the order of the other element (step S2203). Thereafter, the information processing apparatus 100 ends the comparison processing.

The information processing apparatus 100 may perform the processing by switching the order of processing of some steps in each of the flowcharts illustrated in FIGS. 17 to 22. The information processing apparatus 100 may skip the processing of some steps in each of the flowcharts illustrated in FIGS. 17 to 22.

As described above, the information processing apparatus 100 may store, in order, a plurality of pieces of value data that represent values of a number of digits with which as many values as a constant multiple of a number of pieces of data included in a data group are representable and that are associated with respective different pieces of data included in the data group. The information processing apparatus 100 may store flag information that defines an upper-lower relationship between a first range and a second range among a plurality of ranges which are set for the values of the number of digits and in each of which at least the number of pieces of data is representable. The information processing apparatus 100 may set, with reference to the flag information, a value that belongs to a lower range among the first range and the second range to each piece of value data of the plurality of pieces of value data. The information processing apparatus 100 may, each time designation of first value data to be moved to a head in the order among the plurality of pieces of value data is accepted, set, with reference to the flag information, a value that belongs to an upper range among the first range and the second range to the first value data. The information processing apparatus 100 may, in response to a piece of value data to which a value that belongs to the lower range has been set no longer existing among the plurality of pieces of value data, update the flag information such that the upper-lower relationship between the first range and the second range is switched. Accordingly, the information processing apparatus 100 may appropriately perform movement of data to the head in the order and may appropriately manage the order relationship between pieces of data.

The information processing apparatus 100 may store flag information that defines the upper-lower relationship between the first range and the second range and an upper-lower relationship between a third range and a fourth range that are lower than the first range and the second range among the plurality of ranges. The information processing apparatus 100 may set, with reference to the flag information, a value that belongs to the lower range among the first range and the second range or a value that belongs to an upper range among the third range and the fourth range, to each piece of value data of the plurality of pieces of value data. The information processing apparatus 100 may, each time designation of the first value data is accepted, set, with reference to the flag information, a value that belongs to the upper range among the first range and the second range to the first value data. The information processing apparatus 100 may, each time designation of second value data to be moved to a tail in the order among the plurality of pieces of value data is accepted, set, with reference to the flag information, a value that belongs to a lower range among the third range and the fourth range to the second value data. The information processing apparatus 100 may detect, with reference to the flag information, pieces of value data to which a value that belongs to the lower range among the first range and the second range and a value that belongs to the upper range among the third range and the fourth range have been set no longer existing. The information processing apparatus 100 may, in response to the detection, update the flag information such that the upper-lower relationship between the first range and the second range is switched and the upper-lower relationship between the third range and the fourth range is switched. Accordingly, the information processing apparatus 100 may appropriately perform movement of data to the tail in the order and may appropriately manage the order relationship between pieces of data.

The information processing apparatus 100 may identify third value data that is last in the order among pieces of value data to which values that belong to the lower range among the first range and the second range or values that belong to the upper range among the third range and the fourth range have been set. The information processing apparatus 100 may set a value that belongs to the lower range among the third range and the fourth range to the third value data. The information processing apparatus 100 may identify fourth value data that is first in the order among pieces of value data to which values that belong to the lower range among the first range and the second range or values that belong to the upper range among the third range and the fourth range have been set. The information processing apparatus 100 may set a value that belongs to the upper range among the first range and the second range, to the fourth value data. Accordingly, the information processing apparatus 100 may prepare value data to which a value that belongs to the lower range among the third range and the fourth range is set, and may prepare value data to which a value that belongs to the upper range among the first range and the second range is set. Thus, the information processing apparatus 100 may improve the stability of the processing.

The information processing apparatus 100 may identify fifth value data that is first in the order among pieces of value data to which values that belong to the lower range among the first range and the second range and values that belong to the upper range among the third range and the fourth range have been set. The information processing apparatus 100 may set a value that belongs to the upper range among the first range and the second range, to the fifth value data. The information processing apparatus 100 may identify sixth value data that is last in order among the pieces of value data to which values that belong to the lower range among the first range and the second range and values that belong to the upper range among the third range and the fourth range have been set. The information processing apparatus 100 may set a value that belongs to the lower range among the third range and the fourth range to the sixth value data. Accordingly, the information processing apparatus 100 may, after the update of the flag information, prepare value data to which a value that belongs to the lower range among the third range and the fourth range is set, and prepare value data to which a value that belongs to the upper range among the first range and the second range is set. Thus, the information processing apparatus 100 may improve the stability of the processing.

The information processing method described in the present embodiment may be implemented by causing a computer, such as a PC or a workstation, to execute a program prepared in advance. The information processing program described in the present embodiment is recorded on a computer-readable recording medium and is read from the recording medium to be executed by the computer. The recording medium is a hard disk, a flexible disk, a compact disc (CD)-ROM, a magneto optical (MO) disc, a Digital Versatile Disc (DVD), or the like. The information processing program described in the present embodiment may be distributed via a network, such as the Internet.

In relation to the embodiment described above, appendices below are further disclosed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
storing, in order, a plurality of pieces of value data that represent values of a number of digits with which a constant multiple of a number of pieces of data included in a data group are representable and that are associated with respective different pieces of data included in the data group;
storing flag information that defines an upper-lower relationship between a first range and a second range among a plurality of ranges which are set for the values of the number of digits and in each of which at least the number of pieces of data is representable;
setting, with reference to the flag information, a value that belongs to a lower range among the first range and the second range to each piece of value data of the plurality of pieces of value data;
each time designation of first value data to be moved to a head in the order among the plurality of pieces of value data is accepted, setting, with reference to the flag information, a value that belongs to an upper range among the first range and the second range to the first value data such that the first value data is before other pieces of value data in the order; and
in response to a piece of value data to which a value that belongs to the lower range has been set no longer existing among the plurality of pieces of value data, updating the flag information such that the upper-lower relationship between the first range and the second range is switched.

2. The non-transitory computer-readable recording medium according to claim 1, wherein
the flag information defines the upper-lower relationship between the first range and the second range and an upper-lower relationship between a third range and a fourth range that are lower than the first range and the second range among the plurality of ranges, and
the process further comprises:
setting, with reference to the flag information, a value that belongs to the lower range among the first range and the second range or a value that belongs to an upper range among the third range and the fourth range, to each piece of value data of the plurality of pieces of value data;
each time designation of the first value data is accepted, setting, with reference to the flag information, a value that belongs to the upper range among the first range and the second range to the first value data such that the first value data is before the other pieces of value data in the order;
each time designation of second value data to be moved to a tail in the order among the plurality of pieces of value data is accepted, setting, with reference to the flag information, a value that belongs to a lower range among the third range and the fourth range to the second value data such that the second value data is after other pieces of value data in the order; and
in response to pieces of value data to which a value that belongs to the lower range among the first range and the second range and a value that belongs to the upper range among the third range and the fourth range have been set no longer existing with reference to the flag information, updating the flag information such that the upper-lower relationship between the first range and the second range is switched and the upper-lower relationship between the third range and the fourth range is switched.

3. The non-transitory computer-readable recording medium according to claim 2, wherein the process further comprises:
when a value that belongs to the upper range among the first range and the second range is set to the first value data with reference to the flag information in response to acceptance of designation of the first value data, setting a value that belongs to the lower range among the third range and the fourth range to third value data that is last in the order among a piece of value data to which a value that belongs to the lower range among the first range and the second range has been set and a piece of value data to which a value that belongs to the upper range among the third range and the fourth range has been set; and
when a value that belongs to the lower range among the third range and the fourth range is set to the second value data with reference to the flag information in response to acceptance of designation of the second value data, setting a value that belongs to the upper range among the first range and the second range to fourth value data that is first in the order among a piece of value data to which a value that belongs to the lower range among the first range and the second range has been set and a piece of value data to which a value that belongs to the upper range among the third range and the fourth range has been set.

4. The non-transitory computer-readable recording medium according to claim 2, wherein the process further comprises:
after the flag information is updated,
setting, with reference to the flag information, a value that belongs to the upper range among the first range and the second range to fifth value data that is first in the order and a value that belongs to the lower range among the third range and the fourth range to sixth value data that is last in the order, among a piece of value data to which a value that belongs to the lower range among the first range and the second range has been set and a piece of value data to which a value that belongs to the upper range among the third range and the fourth range has been set.

5. An information processing method performed by a computer, the method comprising:
storing, in order, a plurality of pieces of value data that represent values of a number of digits with which a constant multiple of a number of pieces of data included in a data group are representable and that are associated with respective different pieces of data included in the data group;
storing flag information that defines an upper-lower relationship between a first range and a second range among a plurality of ranges which are set for the values of the number of digits and in each of which at least the number of pieces of data is representable;
setting, with reference to the flag information, a value that belongs to a lower range among the first range and the second range to each piece of value data of the plurality of pieces of value data;
each time designation of first value data to be moved to a head in the order among the plurality of pieces of value data is accepted, setting, with reference to the flag information, a value that belongs to an upper range among the first range and the second range to the first value data such that the first value data is before other pieces of value data in the order; and
in response to a piece of value data to which a value that belongs to the lower range has been set no longer existing among the plurality of pieces of value data, updating the flag information such that the upper-lower relationship between the first range and the second range is switched.

6. An information processing apparatus comprising:
a memory, and
a processor coupled to the memory and configured to:
store, in order, a plurality of pieces of value data that represent values of a number of digits with which a constant multiple of a number of pieces of data included in a data group are representable and that are associated with respective different pieces of data included in the data group;
store flag information that defines an upper-lower relationship between a first range and a second range among a plurality of ranges which are set for the values of the number of digits and in each of which at least the number of pieces of data is representable;
set, with reference to the flag information, a value that belongs to a lower range among the first range and the second range to each piece of value data of the plurality of pieces of value data;
each time designation of first value data to be moved to a head in the order among the plurality of pieces of value data is accepted, set, with reference to the flag information, a value that belongs to an upper range among the first range and the second range to the first value data such that the first value data is before other pieces of value data in the order; and
in response to a piece of value data to which a value that belongs to the lower range has been set no longer existing among the plurality of pieces of value data, update the flag information such that the upper-lower relationship between the first range and the second range is switched.
